(19) United States
(12) Patent Application Publication
(10) Pub. No.: US 2014/0190346 A1
(43) Pub. Date: Jul. 10, 2014

(54) Economizer Device For Linear Pneumatic Actuator

(71) Applicant: Enzo Landi, San Lazzaro di Savena (IT)

(72) Inventor: Enzo Landi, San Lazzaro di Savena (IT)

(21) Appl. No.: 14/219,338

(22) Filed: Mar. 19, 2014

Related U.S. Application Data
(63) Continuation of application No. PCT/IB2012/054947, filed on Sep. 18, 2012.

(30) Foreign Application Priority Data
Sep. 19, 2011 (IT) MO2011A000237

(51) Int. Cl. F15B 15/02

(52) U.S. Cl. CPC F15B 15/02
USPC 91/418; 91/471

(57) ABSTRACT

An economizer device associable with a linear pneumatic actuator includes a body having openings and a Venturi vacuum generator slidably housed in a first conduit. The device operates between a first operating configuration, where a first opening is supplied with air at an operating pressure and the vacuum generator moves in the first conduit to permit primary flow of air and to reduce outlet pressure thereof from a second opening so as to supply the chamber of the actuator with air at a reduced pressure lower than the operating pressure, and a second operating configuration, where the first opening is connected to the environment at atmospheric pressure and a third opening is supplied with pressurized air with which it supplies the vacuum generator, which creates a vacuum in the second opening in such a manner as to suck air from and create a vacuum in the chamber.

### FIELD OF THE INVENTION

The invention relates to pneumatic plants and circuits for apparatuses and operating machines and, in particular, it refers to an economizer device that is installable on linear pneumatic actuators to reduce the consumption of compressed air thereof whilst maintaining performance unvaried. The invention further relates to a movement apparatus comprising a linear pneumatic actuator provided with an economizer device and a method for driving a linear pneumatic actuator.

### BACKGROUND OF THE INVENTION

Known linear pneumatic actuators are typically pneumatic cylinders that comprise a casing or hollow external container (cylinder) inside which a piston with stem slides that divides the interior of the cylinder into two chambers. In single-acting cylinders only one of the chambers is supplied with compressed air so as to exert a thrust force onto the piston in a single direction and during one of the strokes of the latter (forward stroke). In double-acting cylinders, both chambers are selectively supplied with compressed air to exert respective thrust and traction forces onto the piston during the strokes (forward and backward strokes).

The pneumatic cylinders are generally used in apparatuses and operating machines, inserted into pneumatic plants or circuits comprising, in addition to other components (rotating actuators, valves, distributors, regulators, etc.), a compression arrangement that is able to supply compressed air at the required supply pressure, typically comprised between 1 and 7 bar (0.1-0.7 Mpa). The compression arrangement comprises one or more compressors provided with electric motors or internal combustion engines.

In the analysis of running costs of an apparatus or of an operating machine and, more in general, of a manufacturing company provided with a plurality of operating machines and of pneumatic plants, the cost of producing compressed air is rather a significant percentage of total operating costs. This cost comprises not only the energy cost (e.g. electric energy) required for supplying the compression arrangement, but also the cost of routine and extraordinary maintenance of the latter, the use of air cleaning and filtering systems, removal of condensate, air-cooling, etc. In particular, the quantity of energy required to produce compressed air is directly proportional to the value of the operating pressure required in the plant (typically 6-7 bar).

Recent studies have shown that by reducing operating pressure by 1 bar (for example from 6 to 5 bar) a saving, only in (electric) energy could be obtained of 9 to 10 percentage points. Further, by operating at lower pressure the compression arrangement would be under less strain and would require less routine and extraordinary maintenance.

Operating pressure is calculated in such a manner as to ensure correct operation of the apparatuses and of the machines in all the operating stations and installations or work points, in particular in the work points in which higher pressure is required. Using lower operating pressure in a pneumatic plant would thus enable energy to be saved but would lower performance or even lead to a malfunction at the work points where pressure is higher.

### SUMMARY OF THE INVENTION

An object of the invention is to improve known pneumatic plants, in particular pneumatic plants for apparatuses and operating machines provided with linear pneumatic actuators.

Another object is to supply an economizer device that is installable on a linear pneumatic actuator and a method for controlling a linear pneumatic actuator that enables compressed air consumption to be lowered whilst maintaining unchanged performance (thrust and traction force on the piston, speed, acceleration) of the latter.

A further object is to make an economizer device that is compact, with modest bulk and dimensions and is easily installable on or integratable into a linear pneumatic actuator.

Still another object is to provide an economizer device having reliable and safe operation, that ensures optimum performance to the linear pneumatic actuator associated therewith.

Another further object is to make an economizer device that is installable on linear pneumatic actuators of a pneumatic plant and a method for controlling a linear pneumatic actuator, that enable the energy (e.g. electric energy) consumption to be reduced significantly that is required for supplying air to a compressing arrangement of the aforesaid plant and for also reducing wear to the aforesaid compression arrangement and the costs of routine and extraordinary maintenance thereof and of the costs of cleaning and filtering the air, eliminating condensate and cooling the air.

In a first aspect of the invention, it is provided a device comprising a body having a first opening selectively connectable to a source of pressurized air or to an environment at atmospheric pressure, a second opening connectable to a chamber of the linear pneumatic actuator, and a third opening selectively connectable to a source of pressurized air, the openings being connected together by a first conduit. The device further includes a Venturi vacuum generator slidably housed and movable in the first conduit. The device is arranged for operating between a first operating configuration, in which the first opening is supplied with air at an operating pressure and the Venturi vacuum generator is movable in the first conduit to permit a primary flow of air and to reduce an outlet pressure thereof from the second opening so as to supply the chamber with air at a reduced pressure lower than the operating pressure, and a second operating configuration, in which the first opening is connected to the environment at atmospheric pressure and the third opening is supplied with pressurized air with which it supplies the Venturi vacuum generator that creates a vacuum in the opening in such a manner as to suck air from and create a vacuum in the chamber of the linear pneumatic actuator.

In a second aspect of the invention, a movement apparatus is provided. The movement apparatus comprises a linear pneumatic actuator provided with a casing and a piston that is slidable inside the casing and defines a first chamber and a second chamber inside the latter, and further comprises an economizer device associated with the second chamber. A first opening of the device is selectively connectable to a source of pressurized air or to an environment at atmospheric pressure, a second opening of the device is connected to the second chamber, and a third opening of the device is connectable to a source of pressurized air, wherein the first chamber is selectively connectable to a source of pressurized air or to an environment at atmospheric pressure

In a third aspect, a method is provided for controlling a linear pneumatic actuator having a casing and a piston that is slidable inside the casing and defines two chambers in the casing. Such method includes the steps of supplying one of the chambers with pressurized air and sucking air from and creating a vacuum in the remaining chamber in such a manner that to a force generated on the piston by the pressurized air in a chamber a further force is added generated by the vacuum created in the remaining chamber.

In a fourth aspect, a movement apparatus having a linear pneumatic actuator provided with a casing and with a piston that is slidable inside that casing and that defines a first chamber and a second chamber inside the casing is provided. The apparatus includes an economizer device associated with the second chamber and provided with a body having a first opening selectively connectable to a source of pressurized air or to an environment at atmospheric pressure, a second opening connectable to the second chamber and connected to the first opening by a first conduit, and a third opening selectively connectable to a source of pressurized air and connected to the first opening and to the opening by a Venturi vacuum generator. The economizer device is arranged for operating between a first operating configuration, in which the first opening is supplied with pressurized air to permit a primary flow of air through the first conduit to supply the second chamber, and a second operating configuration, in which the first opening is connected to the environment at atmospheric pressure, the third opening is supplied with pressurized air with which it supplies the Venturi vacuum generator, which creates a vacuum in the second opening in such a manner as to suck air from, and create a vacuum in, the second chamber.

### BRIEF DESCRIPTION OF THE DRAWINGS

The invention can be better understood and implemented with reference to the attached drawings that illustrate some embodiments thereof by way of non-limiting example, in which:

FIG. 1 is a schematic cross section of the economizer device of the invention in a closed position;

FIG. 2 is a partially sectioned schematic view of a movement apparatus comprising the economizer device in FIG. 1 associated with a linear pneumatic actuator and in a first operating configuration;

FIG. 3 is a partially sectioned schematic view of the movement apparatus in FIG. 2 in a second operating configuration;

FIG. 4 is a partially sectioned schematic view of a version of the movement apparatus comprising two economizer devices in FIG. 1 associated with a linear pneumatic actuator;

FIG. 5 is a partially sectioned frontal view of a version of the economizer device of the invention associated with and integrated into a linear pneumatic actuator;

FIG. 6 is a schematic cross section of another version of the economizer device of the invention;

FIG. 7 is a partially sectioned schematic view of a movement apparatus of the invention comprising two economizer devices in FIG. 6 associated with a linear pneumatic actuator and in a first operating configuration;

FIG. 8 is a partially sectioned schematic view of the movement apparatus in FIG. 7 in a second operating configuration; and

FIG. 9 is a partially sectioned schematic view of a version of the movement apparatus of the invention.

### DETAILED DESCRIPTION OF THE INVENTION

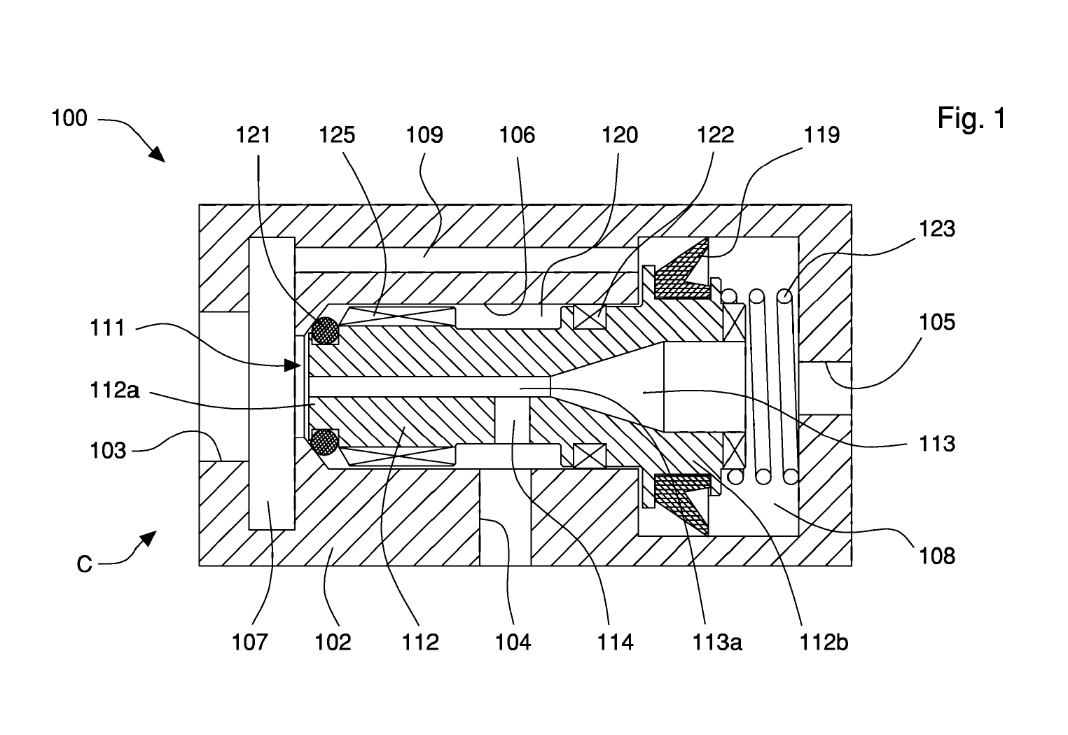

With reference to FIGS. 1 to 3, an economizer device 100 according to the invention is illustrated that is associated with a linear pneumatic actuator 20, in particular a pneumatic cylinder, comprising an external casing 21 (cylinder) and a piston 22 provided with a stem 25 and slidable inside said casing 21, defining in the latter a first chamber 23 and a second chamber 24.

The economizer device 100 comprises a body 102 of substantially cylindrical or prismatic shape, provided with a first opening 103 that can be selectively connected to a source of pressurized air or to an environment at atmospheric pressure (exhausted), a second opening 104 connectable to one of the chambers 23, 24 of the pneumatic cylinder 20, for example to the second chamber 24, and a third opening 105 selectively connectable to a source of pressurized air.

The openings 103, 104, 105 are connected together by a first conduit 106 in which a Venturi vacuum generator, or Venturi vacuum pump 111 is slidably housed and movable.

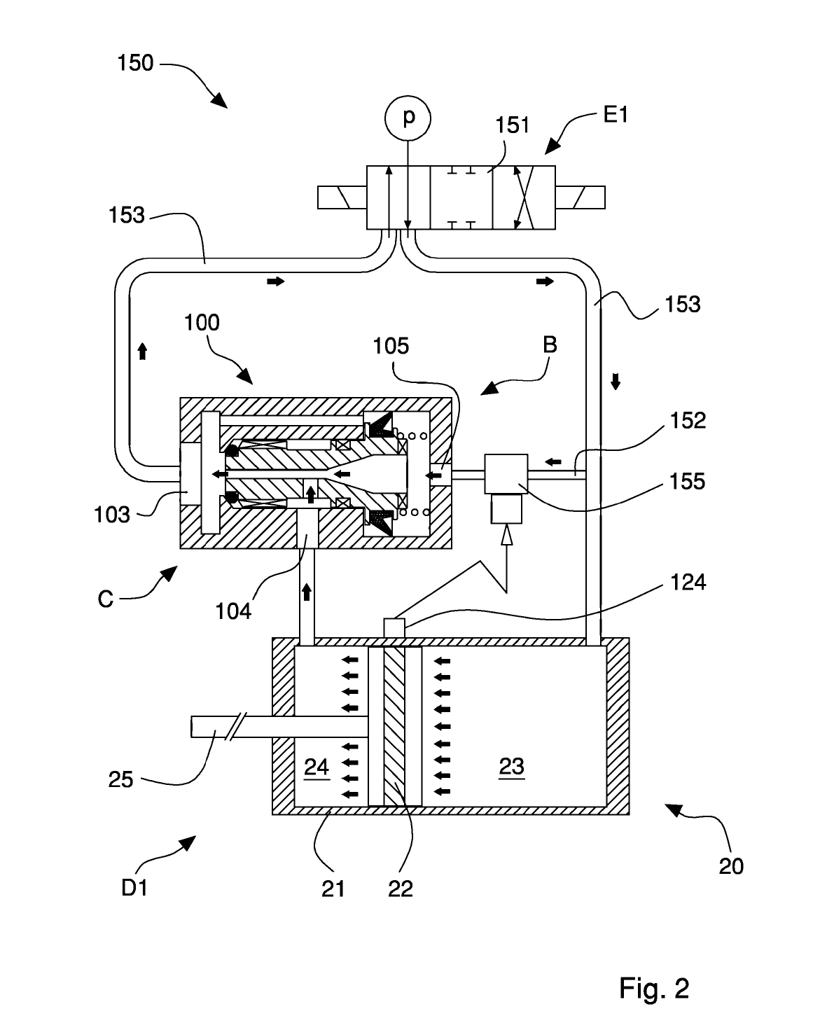

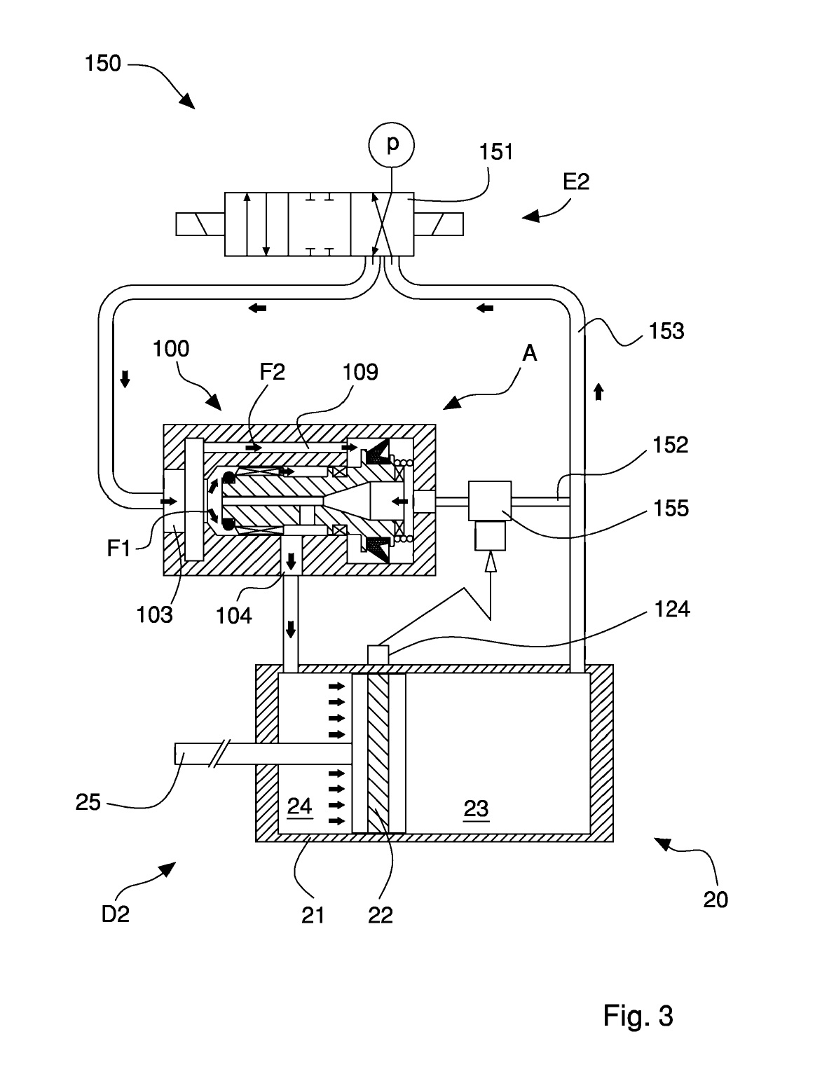

As explained better further on in the description, the device 100 is arranged for operating between a first operating configuration A and a second operating configuration B. In the first operating configuration A (FIG. 3), the first opening 103 is supplied with air at an operating pressure p and the Venturi vacuum generator 111 is movable in the first conduit 106 to permit a primary air flow F1 and for reducing pressure of said air exiting the second opening 104 so as to supply the chamber with air at a reduced pressure pᵣ lower than the operating pressure p. In the second operating configuration B (FIG. 2), the first opening 103 is connected to the environment at atmospheric pressure, the third opening 105 is supplied with pressurized air and the Venturi vacuum generator 111 is supplied with pressurized air coming from the third opening 105 and creates a vacuum in the second opening 104 in such a manner as to suck air from, and creating a vacuum in the second chamber 24 of the linear pneumatic actuator 20.

The Venturi vacuum generator 111 comprises a further body 112, of elongated and substantially cylindrical shape, slidably inserted into the first conduit 106 and provided with a longitudinal variable section conduit 113 suitable for connecting the first opening 103 to the third opening 105 and a transverse side passage 114 suitable for connecting a smaller section portion 113a of the longitudinal variable section conduit 113 to the second opening 104. The passage of pressurized air through the longitudinal variable section conduit 113 determines at the smaller section portion 113a, where the air flow speed increases owing to the narrowing of the section, a drop in air pressure by Venturi effect that is such as to cause air to be sucked through the side passage 114 from the second opening 104 and thus from the second chamber 24 of the linear pneumatic actuator 20 connected thereto. A vacuum is thus created in the second chamber 24.

The further body 112 of the Venturi vacuum generator 111 slidably inserted into the first conduit 106 comprises a first portion 112a facing the first opening 103 and shaped in such a manner as to form with a side wall of the first conduit 106 a gap 120 for the passage of the air from the first opening 103 to the second opening 104 in the first operating configuration A. As illustrated in FIG. 1, the first shaped portion 112a comprises a series of peripheral longitudinal grooves 125, angularly regularly spaced apart from one another that enable the air to pass through the gap 120.

The first conduit 106 and the Venturi vacuum generator 111 are configured in such a manner that in the second operating configuration B the aforesaid Venturi vacuum generator 111, arranged in a closed position C, is able to close the gap 120 and prevent the passage of pressurized air between the second opening 104 and the first opening 103. In particular, in the closed position C an end of the first portion 112a of the further body 112 abuts on a side wall of the first conduit 106. A first seal element 121 fixed to the aforesaid end of the first portion 112a abuts on the side wall of the first conduit 106 in such a manner as to separate the gap 120 hermetically from the first opening 103. A second seal element 122 fixed to a second portion 112b of the further body 112 abuts on the side wall of the first conduit 106 in such a manner as to separate the gap 120 hermetically from the third opening 105.

The device 100 further comprises an elastic member 123 acting on the Venturi vacuum generator 111 to maintain the latter in the closed position C. The elastic member comprises, for example, a coil spring.

The body 102 of the device 100 further comprises a front chamber 107 interposed between the first opening 103 and the first conduit 106, a rear chamber 108 interposed between the third opening 105 and the first conduit 106 and a second conduit 109 that connects the front chamber 107 to the rear chamber 108 to permit in the first operating configuration A a secondary flow F2 of pressurized air directed from the first opening 103 to the rear chamber 108. As explained better further on in the description, the pressurized air in the front chamber 107 and the pressurized air in the rear chamber 108 exert respective opposite thrusts on the Venturi vacuum generator 111 that are such as to move the latter along the first conduit 106.

On-off member 119 is provided, in particular in the rear chamber 108, to permit, in the first operating configuration A, the passage of air through the second conduit 109 directed from the first opening 103 to the third opening 105 (secondary flow F2) and prevent, in the second operating configuration B, an air flow through the second conduit 109 and directed from the third opening 105 to the first opening 103. The on-off member 119 comprises a single-acting valve that substantially includes an annular lip seal fixed to an end of said Venturi vacuum generator 111 facing the third opening 105 and at said rear chamber 108.

With reference to FIGS. 2 and 3, a movement apparatus 150 is illustrated comprising the linear pneumatic actuator 20 and an economizer device 100 according to the invention, said device 100 being associated with one of the chambers of the linear pneumatic actuator, for example, with the second chamber 24. The first opening 103 of the device 100 is selectively connectable to a source of pressurized air or to an environment at atmospheric pressure by a respective supply conduit 153, the second opening 104 of the device 100 is connected to the second chamber 24 and the third opening 105 of the device 100 is connectable to a source of pressurized air. The first chamber 23 of the linear pneumatic actuator 20 is selectively connectable to a source of pressurized air or to an environment at atmospheric pressure by a respective supply conduit 153.

The device 100 is removably connected to the casing 21, in particular the second opening 104 is coupled to the second chamber 24 by a pneumatic connecting arrangement comprising, for example, a pneumatic connection of known type.

The apparatus 150 comprises a valve switching device 151 connected to the first opening 103 and to the third opening 105 of the device 100 and to the first chamber 23 of the linear pneumatic actuator 20. In particular, the first opening 103 and the first chamber 23 are connected to the valve switching device 151 by respective supply conduits 153, whilst the third opening 105 is connected to the supply conduit 153 that connects the camera 23 to the valve switching device 151 by a connecting conduit 152.

The valve switching device 151 is selectively activatable at least between a first switching position E1 and a second switching position E2.

In the first switching position E1 (FIG. 2) the valve switching device 151 connects the first opening 103 to an environment at atmospheric pressure and sends pressurized air to the first chamber 23, to move the piston 22 along a forward or operating stroke and to the third opening 105 to enable air to be extracted from the second chamber 24 through the device 100. The latter is arranged in the second operating configuration B in such a manner that to a force generated on the piston 22 by the pressurized air in the first chamber 23 a further force is added generated by the vacuum made in the second chamber 24.

With the valve switching device 151 in the first switching position E1 the movement apparatus 150 and the pneumatic actuator 20 are arranged in a first working configuration D1.

In the second switching position E2 (FIG. 3) the valve switching device 151 connects the first chamber 23 to the environment at atmospheric pressure and sends pressurized air to the first opening 103. The device 100 arranged in the first operating configuration A thus reduces a supply pressure of the air in the second chamber 24 and thus enables air consumption to be reduced in the movement of the piston 22 in a backward stroke.

With the valve switching device 151 in the second switching position E2 the movement apparatus and the pneumatic actuator 20 are arranged in a second working configuration D2.

In a third switching position, which is not illustrated in the Figures, the valve switching device 151 closes the first opening 103, the third opening 105 and the first chamber 23 so as to maintain the piston 22 of the linear pneumatic actuator 20 in a stable and fixed position.

The valve switching device 151 comprises, for example, a three-position four-way pneumatic solenoid valve. Alternatively, the valve switching device 151 can comprise a two-position four-way pneumatic solenoid valve.

The movement apparatus further comprises an on/off valve arrangement 155 interposed between the third opening 105 and the valve switching device 151 and activatable via a sensor 124 by the piston 22 to permit or prevent the passage of pressurized air into the third opening 105, when the valve switching device 151 is in the first switching position E1, on the basis of at least one linear position of the piston 22 along the casing 21.

The sensor 124, for example of magnetic type, is in fact fixed to the casing 21 of the linear pneumatic actuator 20 to detect a preset position of the piston 22, in particular during the work stroke, in such a manner as to activate the on/off valve arrangement 155 and to enable the third opening 105 and thus the Venturi vacuum generator 111 to be supplied with pressurized air only for a set portion of the work stroke of the piston 22.

Operation of the economizer device 100 of the invention can be disclosed with reference to the movement apparatus 150, in which said economizer device 100 is associated with the linear pneumatic actuator 20.

In the first working configuration D1 of the movement apparatus 150 and of the pneumatic actuator 20 with the valve switching device 151 activated and arranged in the first switching position E1, the first chamber 23 of the pneumatic actuator 20 is supplied with pressurized air, the device 100 receives pressurized air from the third opening 105 whereas the first opening 103 is exhaust, connected by the valve switching device 151 with the environment at atmospheric pressure. The device 100 is then arranged in the second operating configuration B and the Venturi vacuum generator 111 supplied by the pressurized air coming from the third opening 105 is in the closed position C and creates a vacuum in the second opening 104 in such a manner as to suck air from, and create a vacuum in the second chamber 24. In this manner, the higher pressure of the air in the first chamber 23 pushes the piston 22 in such a manner as to reduce the volume of the second chamber 24 and, in the embodiment in FIG. 2, enable the exiting of the stem 25 (forward stroke).

It should be noted that to the force generated on the piston 22 by the pressurized air in the first chamber 23 a further force is added that is generated by the vacuum in the second chamber 24.

The device 100 is activated when the pressurized air is delivered into the third opening 105 i.e. when the on/off valve arrangement 155, interposed between the third opening 105 and the valve switching device 151 permits the passage of the air. The on/off valve arrangement 155 is activated by the sensor 124 that detects a preset linear position of the piston 22 inside the casing 21. In other words, the movement apparatus 150 enables a vacuum to be created in the second chamber 24, for example to increase the thrust of the piston 22 in the forward stroke and/or to increase a speed of the latter only for a defined portion of the aforesaid forward stroke, typically the final portion in which the pneumatic actuator has to exert maximum thrust.

In the second working configuration D2 of the movement apparatus 150 and of the pneumatic actuator 20, with the valve switching device 151 activated and arranged in the second switching position E2, the first chamber 23 of the pneumatic actuator 20 is exhausted, connected by the valve switching device 151 to the environment at atmospheric pressure, whilst the device 100 receives pressurized air through the first opening 103 and is arranged in the first operating configuration A. In this first operating configuration A, the Venturi vacuum generator 111 is movable in the first conduit 106 to permit a primary flow F1 of air through the gap 120 of the first conduit 106. At the same time a secondary flow F2 of pressurized air flows through the second conduit 109 from the front chamber 107 to the rear chamber 108.

The pressurized air in the front chamber 107 and the pressurized air in the rear chamber 108 exert respective opposite thrusts on the Venturi vacuum generator 111, so as to move the latter along the first conduit 106 in particular during an initial step in which the pressurized air is delivered into the device through the first opening 103.

Owing to the movement of the Venturi vacuum generator 111 inside the first conduit 106 the dimension and volume of the gap 120 for the passage of the air from the first opening 103 to the second opening 104 vary.

Experimental tests have shown that the effect obtained by the device 100 in this operating step is to reduce the air supply pressure inside the second chamber 24, in particular in the case of a backward stroke of the unloaded piston 22. More precisely, the air passing through the Venturi vacuum generator 111, the gap 120 and the second conduit 109 is in fact subject to resistances and pressure losses that cause a reduction in initial pressure. The device 100 in the first operating configuration A thus enables the operating pressure p of the air supplied by the source of pressurized air to be reduced and the air pressure entering the first opening 103 to be reduced to pᵣ lower than operating pressure p.

Table 1 shown below illustrates the relations recorded by experiment between the values of the operating pressure p and of the reduced pressure pᵣ, in the case of a backward stroke of the piston 22 without load:

TABLE 1

| p (bar) | pᵣ (bar) |
|---|---|
| 3 | 1 |
| 4 | 1-1.2 |
| 5 | 1.2-1.5 |
| 6 | 1.8-2 |

It should be noted that if in the backward stroke the piston 22 has to exert a force (movement of the load) the value of the reduced pressure pᵣ rises proportionally to the size of the load.

Owing to the device 100 of the invention it is thus possible to supply at a reduced pressure (reduced pressure pᵣ) that is about 30% of the supply pressure of the plant (operating pressure p) this enabling compressed air consumption in the backward stroke of the pneumatic actuator 20 to be decreased significantly (70%).

Experimental tests have also shown that the behaviour of the device 100 does not substantially vary if the third opening 105 is exhausted, i.e. connected to the environment at atmospheric pressure or is closed by the on/off valve arrangement 155.

Experimental tests have also been conducted to demonstrate the energy saving that the economizer device 100 of the invention enables to be obtained when it is applied to a pneumatic linear actuator.

With reference to the movement apparatus of FIGS. 2 and 3, the value of the force generated by the cylinder and measured on the stem 25 is a function of the section of the piston 22 (mm²) and of the air pressure (bar) delivered into the chambers 23, 24.

In order to evaluate the cost of an operating cycle of the linear pneumatic actuator 20 (forward stroke and backward stroke) air consumption (Nl—normal litre) has to be measured to run this operating cycle.

If, purely by way of non-limiting example, a cylinder is considered that has a bore D=80 mm, stroke c=200 mm and stem diameter d=25 mm, supplied with air at operating pressure p=6 bar (relative pressure), in the case of a pneumatic cylinder devoid of economizer devices 1 the theoretical thrust force Fₛ₍₆₎ (at 6 bar of operating pressure) in the forward stroke is:

$$\begin{matrix}{F}_{s ( 6 )} = \frac{π {D}^{2} p}{40} \\ = \frac{π \times {80}^{2} \times 6}{40} \\ = 3016 N\end{matrix}$$

Theoretical air consumption in the thrust step Vₛ₍₆₎ (forward stroke) and in the traction step Vₜ₍₆₎ (backward stroke) is:

$$\begin{matrix}{V}_{s ( 6 )} = \frac{π {D}^{2} ( p + 1 )}{4 \cdot {10}^{6}} c \\ = \frac{π \times {80}^{2} \times 7}{4 \cdot {10}^{6}} \times 200 \\ = 7 , 04 N 1\end{matrix}$$

$$\begin{matrix}{V}_{t ( 6 )} = \frac{π ( {D}^{2} - {d}^{2} ) ( p + 1 )}{4 \cdot {10}^{6}} c \\ = \frac{π \times ( {80}^{2} - {25}^{2} ) \times 7}{4 \cdot {10}^{6}} \times 200 \\ = 6 , 35 N 1\end{matrix}$$

Total compressed air consumption Vₜₒₜ₍₆₎ at operating pressure p=6 bar is Vₜₒₜ₍₆₎=Vₛ₍₆₎+Vₜ₍₆₎=13.39 Nl.

If a pneumatic cylinder is considered that is provided with the economizer device 100 of the invention and is supplied with compressed air at an operating pressure p=5 bar, a theoretical thrust force Fₛ₍₅₎ is obtained (at 5 bar of operating pressure) in the forward stroke generated by the air pressure of the first chamber 23 (FIG. 2) equal to:

$$\begin{matrix}{F}_{s ( 5 )} = \frac{π {D}^{2} p}{40} \\ = \frac{π \times {80}^{2} \times 5}{40} \\ = 2513 N\end{matrix}$$

to which a further thrust force F′ₛ₍₅₎ has to be added that is generated by the vacuum (for example p′=−0.94 bar) created by the Venturi vacuum generator 111 inside the second chamber 24 and is equal to:

$$\begin{matrix}{F}_{s ( 5 )}^{′} = \frac{π ( {D}^{2} - {d}^{2} ) p}{40} \\ = \frac{π \times ( {80}^{2} - {25}^{2} ) \times 0 , 94}{40} \\ = 426 N\end{matrix}$$

Total theoretical thrust force Fₛₜₒₜ₍₅₎ is thus equal to:

Fₛₜₒₜ₍₅₎=Fₛ₍₅₎+F′ₛ₍₅₎=2939N

i.e. a value that is very close to the value obtained by supplying 6 bar pressure to the pneumatic cylinder devoid of an economizing apparatus 50.

It is worth pointing out that owing to the economizer device 100 of the invention it is thus possible to obtain the same performance as the pneumatic actuator (thrust force) reducing operating pressure by 1 bar. This reduction enables an approximately 10% saving to be made in the energy (e.g. electric energy) required to produce the pressurized air.

Theoretical air consumption in the thrust step Vₛ₍₅₎ (outward stroke) is:

$$\begin{matrix}{V}_{s ( 5 )} = \frac{π {D}^{2} ( p + 1 )}{4 \cdot {10}^{6}} c \\ = \frac{π \times {80}^{2} \times 6}{4 \cdot {10}^{6}} \times 200 \\ = 6 , 03 N 1\end{matrix}$$

whereas theoretical air consumption in the traction step Vₜ₍ₚᵣ₎ (backward stroke) is considerably reduced as the device 100 in the first operating configuration A enables operating pressure p equal to 5 bar to be reduced to a reduced pressure pᵣ equal to 1.5 bar with which to supply the second chamber 24 and is:

$$\begin{matrix}{V}_{t ( pr )} = \frac{π ( {D}^{2} - {d}^{2} ) \times ( {p}_{r} + 1 )}{4 \cdot {10}^{6}} \times c \\ = \frac{π \times ( {80}^{2} - {25}^{2} ) \times 2 , 5}{4 \cdot {10}^{6}} \times 200 \\ = 2 , 27 N 1\end{matrix}$$

Total compressed air consumption Vₜₒₜ₍₅₎ at operating pressure p=5 bar is thus Vₜₒₜ₍₅₎=Vₛ₍₅₎+Vₜ₍ₚᵣ₎=8.3 Nl.

It is seen that owing to the economizer device of the invention it is possible to save 5.09 Nl (Vₜₒₜ₍₆₎−Vₜₒₜ₍₅₎=13.39−8.3) at each operating cycle of the pneumatic cylinder 20 (in the case of a backward stroke of the piston 22 without load).

If it is assumed, merely by way of example, that the pneumatic cylinder 20 installed on an operating machine performs 12 cycles per minute for 12 hours a day for 230 days/year, 1987000 cycles will be performed in a year. The annual compressed air consumption saving will be about 10114 m³ of compressed air at 5 bar.

It should be noted that the greater the bore dimensions and the dimensions of the pneumatic cylinder stroke the greater will be the compressed air consumption saving.

Owing to the economizer device 100 of the invention, applied to a linear pneumatic actuator, it is thus possible to obtain a considerable saving in compressed air consumption for the same performance provided by the cylinder (thrust and traction force on the piston, speed, acceleration). In particular, it is possible to supply the pneumatic actuators in a plant with an operating pressure reduced by 1 bar, thus enabling energy (e.g. electric energy) consumption to be reduced by about 10%.

In addition to a saving on the energy needed to supply the air-compression arrangement, the economizer device 100 of the invention also enables wear to the aforesaid compression arrangement and routine and extraordinary maintenance costs for the compression arrangement to be reduced. Lower air consumption also enables cleaning, air filtration and cooling and condensate elimination costs to be reduced. The lower energy consumption enables CO₂ emissions into the atmosphere to be reduced with clear benefits for the environment.

By using lower operating pressure, the compression units are not only less stressed but are also less noisy, thus significantly lessening existing acoustic pollution (decibels/hour) in the workplace.

The economizer device 100 of the invention is thus particularly compact with modest space take-up and dimensions and is thus easily installable on any linear pneumatic actuator.

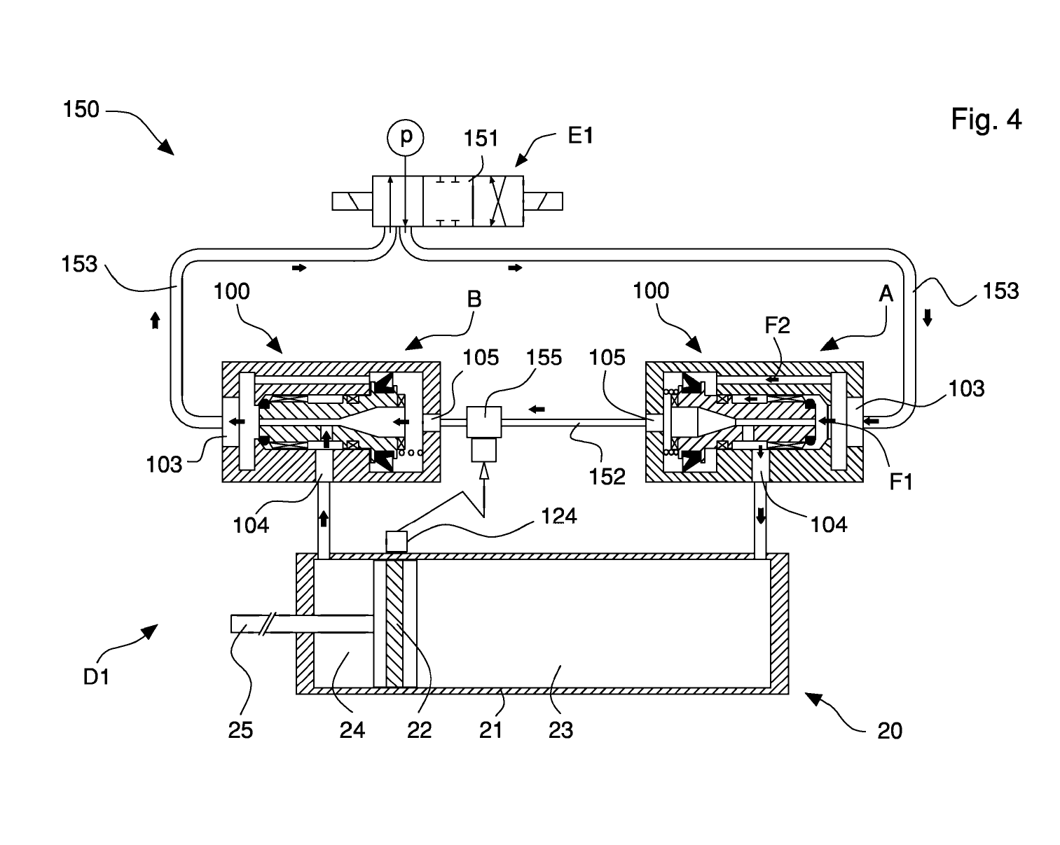

FIG. 4 illustrates a version of the movement apparatus 150 that differs from the embodiment disclosed above and shown in FIGS. 2 and 3 by the fact that it comprises another respective economizer device 100 according to the invention associated with the first chamber 23 of the linear pneumatic actuator 20. A respective first opening 103 of the aforesaid device 100 is selectively connectable to a source of pressurized air or to an environment at atmospheric pressure by a respective supply conduit 153, a respective second opening 104 is connected to the first chamber 23, whereas a respective third opening 105 is connected to the respective third opening 105 of the device 100 associated with the second chamber 24 by a connecting conduit 152.

The valve switching device 151 is in this version of the movement apparatus connected to the first openings 103 of the two devices 100 and is selectively activatable for sending pressurized air into one of the chambers 23, 24 of the linear pneumatic actuator through a respective device 100 arranged in a first operating configuration A and to enable air to be extracted from the remaining chamber 24, 23 through the respective device 100 arranged in the second operating configuration B so as to enable the piston 22 to be moved in such a manner that to a force generated on the piston 22 by the pressurized air in a chamber a further force is added that is generated by the vacuum made in the remaining chamber, both in the operating stroke and in the backward stroke of the aforesaid piston 22. In particular, the device 100 arranged in the second operating configuration B (in the FIG. 4 the device 100 associated with the second chamber 24) has the respective first opening 103 connected to an environment at atmospheric pressure by the valve switching device 151 and receives incoming pressurized air from the respective third opening 105 supplied by pressurized air exiting the respective third opening 105 of the other device 1 (in FIG. 4 the device 100 associated with the first chamber 23) that is arranged in the first operating configuration A.

The operation of this version of the movement apparatus 150 is substantially similar to that of the apparatus in FIGS. 2 and 3.

In the first working configuration D1 of the movement apparatus 150 the valve switching device 151 is arranged in the first switching position E1 and the first chamber 23 of the pneumatic actuator 20 is supplied with pressurized air through the respective device 100 arranged in the first operating configuration A. In particular, the first opening 103 of the device 100 associated with the first chamber 23 is supplied with air at the operating pressure p. The device reduces the air pressure delivered into the first chamber 23 from the operating pressure p to the reduced pressure pᵣ.

The first opening 103 of the device 100 associated with the second chamber 24 is exhausted and connected to the environment at atmospheric pressure, whilst the respective third opening 105 receives pressurized air coming from the respective third opening of the device associated with the first chamber 23. In this manner, the device 100 associated with the second chamber 24 is arranged in the second operating configuration B and the respective Venturi vacuum generator 111 supplied with the pressurized air coming from the third opening 105 is in the closed position C and creates a vacuum in the second opening 104 in such a manner as to suck air from, and creating a vacuum in the second chamber 24. In this manner, to the thrust generated by the pressure (reduced pressure pᵣ) of the air in the first chamber 23 a further force is added that is generated by the vacuum created in the second chamber 24. The value of the pressure in the first chamber increases up to the value of the operating pressure p as the load increases that the piston 22 has to move in the forward stroke. Nevertheless, in the portion of the forward stroke in which the piston 22 meets limited resistance it is possible to supply the first chamber 23 with reduced air pressure, this permitting a considerable energy saving.

Also in this case, the vacuum in the second chamber 24 can be activated by using the on/off valve arrangement 155 according to the position of the piston 22 along the forward stroke, for example to increase the thrust of the piston 22 in the forward stroke and/or to increase the speed of the latter only for a defined portion of the aforesaid forward stroke, typically the final portion in which the pneumatic actuator has to exert maximum thrust. In the second working configuration of the movement apparatus 150 in which the valve switching device 151 is arranged in the second switching position E2 operation of the devices 100 is reversed respectively to supply the second chamber 24 with pressurized air (reduced pressure pᵣ) and to create a vacuum in the first chamber 23.

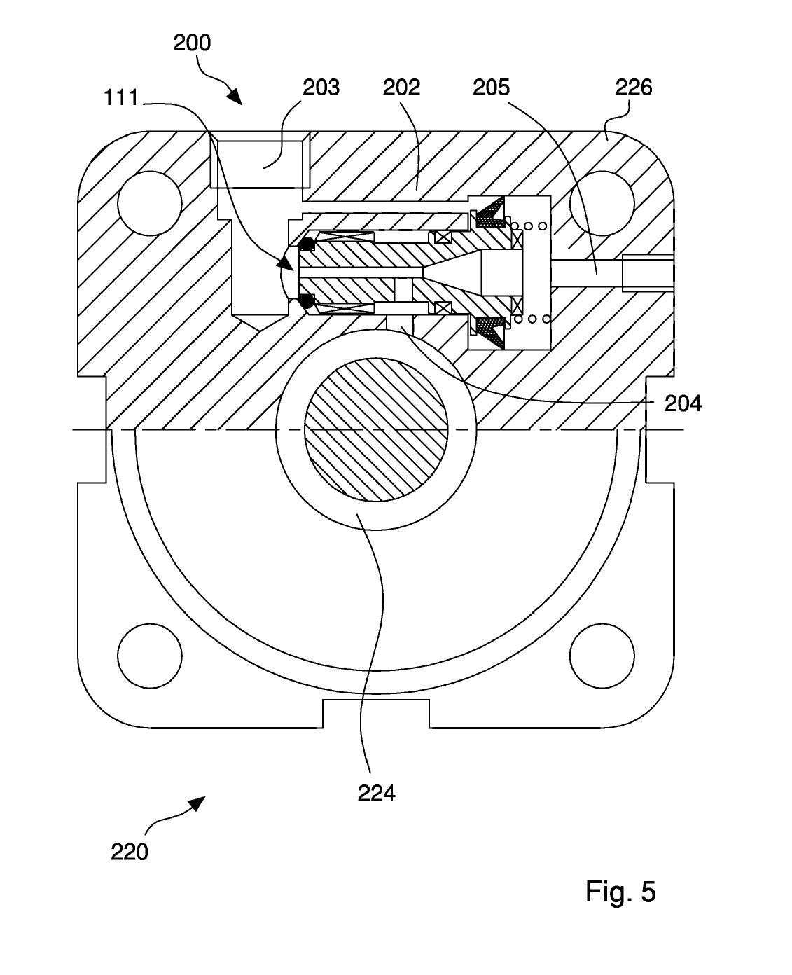

FIG. 5 illustrates a version of the economizer device of the invention that differs from the embodiment disclosed above by the fact that it is integrated into the casing 221 of the linear pneumatic actuator 220. In particular, the device 200 comprises a body 202 made directly in a head 226 of the linear pneumatic actuator 220. In this embodiment, the first opening 203 and the third opening 205 are made in the aforesaid head 226. The second opening 204 is directly connected to a chamber, for example the second chamber 224, of the linear pneumatic actuator.

The movement apparatus comprising the linear pneumatic actuator 220 and the economizer device 200 of the invention is thus particularly compact and reduced, the dimensions of the linear pneumatic actuator 220 being substantially the same as those of a standard actuator. Operation of the movement apparatus is identical to what has been disclosed above.

The invention further comprises a method for driving a linear pneumatic actuator 20 comprising a casing 21 and a piston 22 that is slidable inside the casing 21 and defining two chambers 23, 24 in the latter, wherein said driving comprises supplying with pressurized air one of the chambers and sucking air from and creating a vacuum in the remaining chamber in such a manner that to a force generated on the piston 22 by the pressurized air in a chamber a further force is added that is generated by the vacuum made in the remaining chamber.

Said sucking is made by a Venturi vacuum generator or Venturi vacuum pump supplied with a secondary flow of said pressurized air.

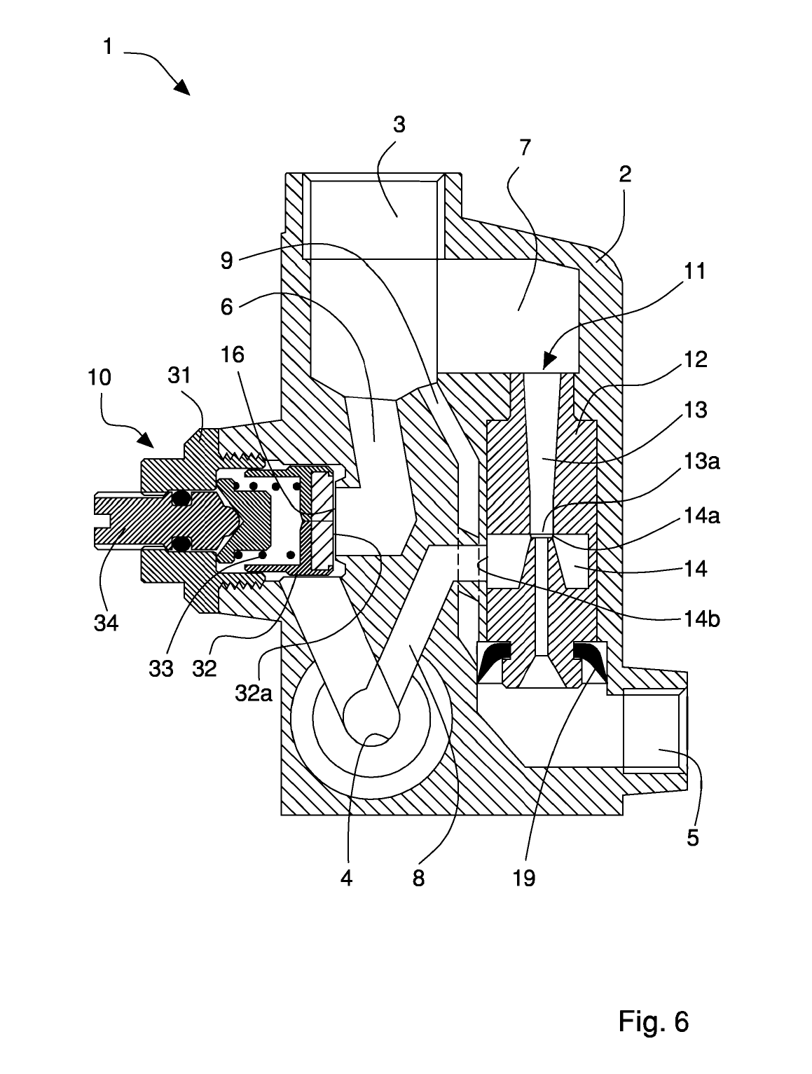

With reference to FIGS. 6 to 9, there is illustrated a version of the economizer device of the invention associated with a linear pneumatic actuator 20, in particular a pneumatic cylinder comprising an external casing 21 (cylinder) and a piston 22 provided with a stem 25 and which is slidable inside said casing 21, defining in the latter a first chamber 23 and a second chamber 24.

The economizer device 1 comprises a body 2 of substantially cylindrical or prismatic shape, provided with a first opening 3 that can be selectively connected to a source of pressurized air or to an environment at atmospheric pressure (exhaust), a second opening 4 connectable to one of the chambers 23, 24 of the pneumatic cylinder and flowingly connected to the first opening 3 by a first conduit 6 provided with a valve arrangement 10, a third opening 5 that can be connected to a source of pressurized air and is flowingly connected to the first opening 3 by a third conduit 7, into which a sucking device 11 is inserted comprising a Venturi vacuum generator (or Venturi vacuum pump), and to the second opening 4 by a fourth conduit 8 that leads into the Venturi vacuum generator 11.

As explained better further on in the description, the device 1 is arranged for operating between a first operating configuration A and a second operating configuration B. In the first operating configuration A, the first opening 3 is supplied with pressurized air and the valve arrangement 10 allows a primary flow F1 of compressed air to pass through the first conduit 6 and to exit the second opening 4 for supplying one of the chambers 23, 24 of the pneumatic cylinder 20 and moving the piston 22. In the second operating configuration B the first opening 3 is connected to the environment at atmospheric pressure and the third opening 5 is supplied with pressurized air; the valve arrangement 10 prevents the passage of air through the first conduit 6 (from the second opening 4 to the first opening 3) and the Venturi vacuum generator, supplied by the pressurized air coming from the third opening 5, creates a vacuum in the fourth conduit 8 and the second opening 4 in such a manner as to suck air from and create a vacuum in the chamber of the cylinder.

The body 2 further comprises a second conduit 9 that connects the first opening 3 to the third opening 5 to permit a secondary flow F2 of compressed air directed from the first opening 3 exiting the third opening 5, in the first operating configuration A.

The valve arrangement 10 comprises a single-acting valve arranged for permitting the flow of pressurized air from the first opening 3 to the second opening 4 and preventing the air from flowing in the opposite direction, i.e. from the second opening 4 to the first opening 3. The single-acting valve 10 comprises a valve body 31 that is fixed to the body 2 of the device 1 and slidably supports a shutter 32 for shutting a passage section 16 of the first conduit 6. A further elastic member 33 maintains the shutter 32 in a shut position in such a manner as to shut the section of passage 16. The elastic force exerted by the further elastic member 33, comprising for example a compression coil spring, can be adjusted by an adjusting pin 34 engaged, for example by threaded coupling, with the valve body 31 and acting on the elastic member 33. The pressurized air coming from the first opening 3 acting on a front surface 32a of the shutter 32 enables the latter to be moved and thus the passage section 16 to be opened. On the other hand, the pressurized air coming from the second opening 4 contributes to maintaining the shutter 32 in the shut position.

The device 1 comprises a seal element 19 inserted into the second conduit 7 and arranged respectively to permit a flow of pressurized air through the second conduit 9 directed from the first opening 3 to the third opening 5, in the first operating configuration A, and for preventing an air flow through said fourth conduit 9 directed from the third opening 5 to the first opening 3, in the second operating configuration B. The seal element 19 comprises, for example, an annular lip seal fixed to an end of the Venturi vacuum generator. The latter comprises a further body 12 inserted into the third conduit 7 and having a longitudinal conduit 13 with a variable section for flowingly connecting the first opening 3 and the third opening 5. The further body 12 is further provided with a side passage 14 suitable for connecting a smaller section portion 13a of the variable section conduit 13 to the fourth conduit 8. In particular, the side passage 14 comprises an annular chamber that is flowingly connected to the smaller section portion 13a by one or more side openings 14a and with the fourth conduit 8 by a further side opening 14b. The passage of pressurized air through the variable section conduit 13 determines at the smaller section portion 13a, where air flow increases because of the narrowing of the section, a pressure drop (Venturi effect). This pressure drop causes air to be sucked from the fourth conduit 8 and thus from the second opening 4 and from the chamber of the pneumatic cylinder 20 connected thereto.

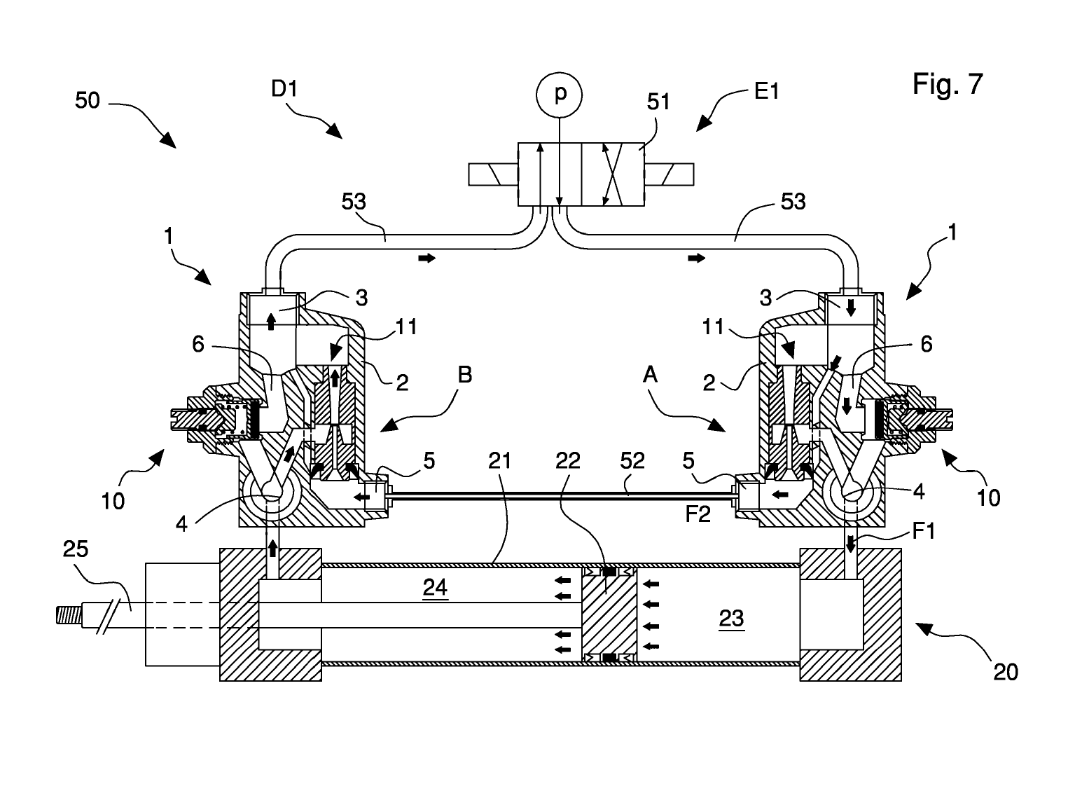

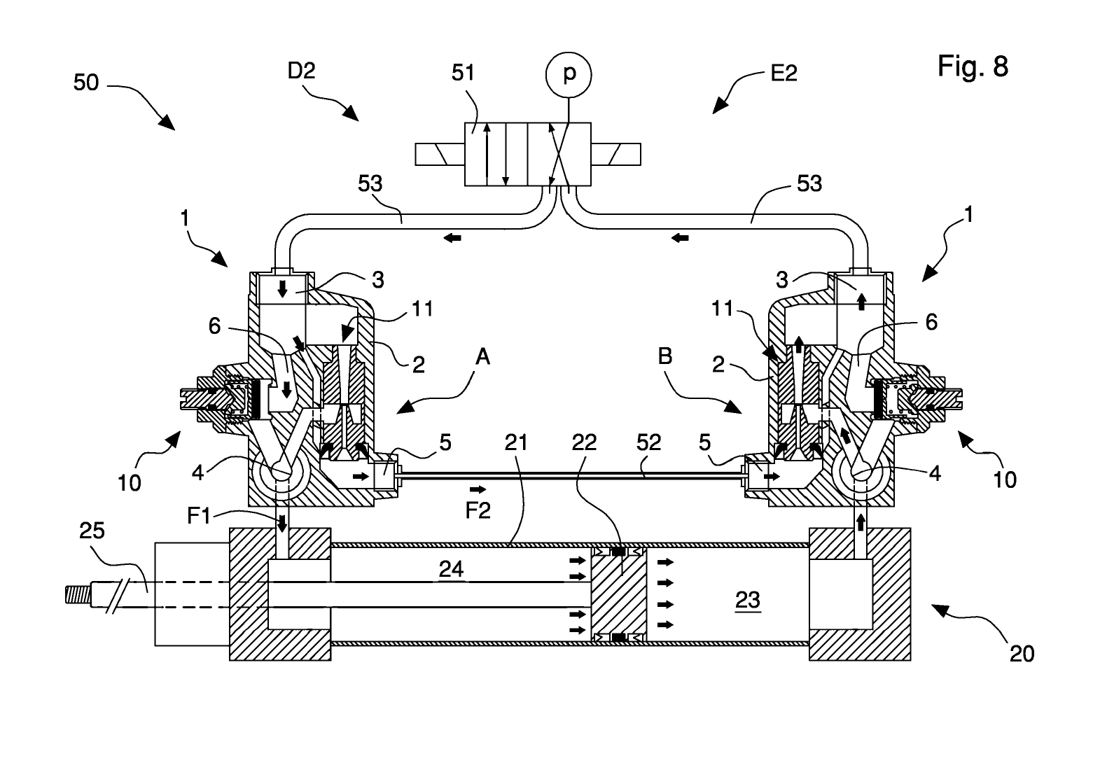

FIGS. 7 and 8 illustrate a movement apparatus 50 comprising a linear pneumatic actuator 20 and two economizer devices 1 of the invention mounted on said linear pneumatic actuator 20. The latter is a double-acting pneumatic cylinder having an external casing 21 (cylinder) and a piston 22 provided with a stem 25, that is slidable inside said casing 21 and defining two chambers 23, 24 in the latter, in particular a first chamber 23 that is not traversed by the stem 25 and a second chamber 24 traversed by the stem 25.

The first opening 3 of each economizer device 1 is selectively connectable to a source of pressurized air or to an environment at atmospheric pressure; the respective second opening 4 of each device 1 is connected to a respective camera 23, 24 of the cylinder 21; the third openings 5 of the devices 1 are connected together by means of a connecting conduit 52.

The movement apparatus 50 further comprises a valve switching device 51 connected to the first openings 3 of the devices 1 by respective supply conduits 53 and is selectively activatable for sending pressurized air in one of the chambers of the pneumatic cylinder 20 through a respective device 1 arranged in the first operating configuration A and enabling air to be extracted from the remaining chamber through a respective device 1 arranged in the second operating configuration B, such as to enable the piston 22 to be moved. The device 1 arranged in the second operating configuration B receives pressurized air through the connecting conduit 52 from the device 1 arranged in the first operating configuration A.

The valve switching device 51 comprises, for example, a two-position four-way bistable pneumatic solenoid valve.

As illustrated in FIG. 7, in a first switching position E1, the solenoid valve 51 supplies with pressurized air the first chamber 23 of the cylinder 21—placing the device 1 connected thereto in the first operating configuration A—whilst it exhausts (connects to the environment at atmospheric pressure) the device 1 connected to the second chamber 24 of the cylinder 21, said device being arranged in the second operating configuration B. With the solenoid valve 51 in the first switching position E1 the apparatus 50 and the pneumatic cylinder 20 are arranged in a first working configuration D1.

The device 1 connected to the first chamber 23 and supplied with compressed air (arranged in the first operating configuration A) enables a primary flow F1 of compressed air to pass through the first conduit 6 and exit the second opening 4 to supply the aforesaid first chamber 23 and enables a secondary flow F2 of compressed air to exit the third opening 5 to supply the device 1 connected to the second chamber 24. The latter device 1, arranged in the second operating position B, enables air to be extracted from the second chamber 24 and a vacuum i.e. lower pressure than atmospheric pressure to be created therein. In particular, in the second operating configuration B the first opening 3 of the device is connected to the environment at atmospheric pressure and the third opening 5 is supplied with pressurized air; the valve arrangement 10 prevents the passage of air through the first conduit 6 and the Venturi vacuum generator 11, supplied by the pressurized air coming from the third opening 5, creates a vacuum in the second opening 4 in such a manner as to suck air from and create a vacuum in the second chamber 24. In this manner the higher air pressure in the first chamber 23 pushes the piston in such a manner as to reduce the volume of the second chamber 24 and, in the embodiment in FIG. 2, enables the stem 25 to exit (forward stroke). It should be noted that to the force generated on the piston 22 by the pressurized air in the first chamber 23 a further force is added that is generated by the vacuum created in the second chamber 24.

As illustrated in FIG. 8, in a second switching position E2, the solenoid valve 51 supplies with pressurized air the second chamber 24 of the cylinder 21—placing the device 1 connected thereto in the first operating configuration A—whilst it exhausts the device 1 connected to the first chamber 23 of the cylinder 21, said device being arranged in the second operating configuration B. With the solenoid valve 51 in the second switching position E2 the apparatus 50 and the pneumatic cylinder 20 are arranged in a second working configuration D2.

The device 1 connected to the second chamber 24 and supplied with compressed air (arranged in the first operating configuration A) enables a primary flow F1 of compressed air to flow through the first conduit 6 and exit the second opening 4 to supply the aforesaid second chamber 24 and to enable a secondary flow F2 of compressed air to exit the third opening 5 to supply the device 1 connected to the first chamber 23. The latter device 1, arranged in the second operating position B enables air to be extracted from the first chamber 23 and a vacuum, i.e. a pressure below atmospheric pressure to be created therein. In this manner the higher air pressure in the second chamber 24 pushes the piston in such a manner as to reduce the volume of the first chamber 24 so as to enable the stem 25 to retract (backward stroke). Also in this case, to the force generated on the piston 22 by the pressurized air in the second chamber 24 a further force is added generated by the vacuum created in the first chamber 23.

Experimental tests have been conducted to demonstrate that the energy saving that the version of the economizer device 1 of the invention enables to be obtained when it is applied to a pneumatic linear actuator.

With reference to the movement apparatus in FIGS. 7 and 8, the value of the force developed by the cylinder and measured on the stem 25 is function of the section of the piston (mm²) and of the air pressure (bar) delivered into the chambers 23, 24.

If it is desired to evaluate the cost of an operating cycle of the linear pneumatic actuator 20 (forward stroke and backward stroke) air consumption (Nl) has to be calculated to perform each operating cycle.

Considering, merely by way of non-limiting example, a cylinder having a bore D=80 mm, stroke c=200 mm and stem diameter d=25 mm, supplied with air at operating pressure p=6 bar (relative pressure), in the case of a pneumatic cylinder devoid of economizer devices the theoretical thrust force Fₛ₍₆₎ (at 6 bar operating pressure) in the forward stroke is:

$$\begin{matrix}{F}_{s ( 6 )} = \frac{π {D}^{2} p}{40} \\ = \frac{π \times {80}^{2} \times 6}{40} \\ = 3016 N\end{matrix}$$

Theoretical air consumption in the thrust step Vₛ₍₆₎ (forward stroke) and in the traction step Vₜ₍₆₎ (backward stroke) are:

$$\begin{matrix}{V}_{s ( 6 )} = \frac{π {D}^{2} ( p + 1 )}{4 \cdot {10}^{6}} c \\ = \frac{π \times {80}^{2} \times 7}{4 \cdot {10}^{6}} \times 200 \\ = 7 , 04 N 1\end{matrix}$$

$$\begin{matrix}{V}_{t ( 6 )} = \frac{π ( {D}^{2} - {d}^{2} ) ( p + 1 )}{4 \cdot {10}^{6}} c \\ = \frac{π \times ( {80}^{2} - {25}^{2} ) \times 7}{4 \cdot {10}^{6}} \times 200 \\ = 6 , 35 N 1\end{matrix}$$

Total compressed-air consumption Vₜₒₜ₍₆₎ at operating pressure p=6 bar is equal to Vₜₒₜ₍₆₎=Vₛ₍₆₎+Vₜ₍₆₎=13.39 Nl.

If a pneumatic cylinder provided with the economizer devices 1 of the invention is considered that is supplied with compressed air at operating pressure p=5 bar, a theoretical thrust force Fₛ₍₅₎ (at 5 bar operating pressure) is obtained in the forward stroke that is generated by the air pressure of the first chamber 23 (FIG. 2) equal to:

$$\begin{matrix}{F}_{s ( 5 )} = \frac{π {D}^{2} p}{40} \\ = \frac{π \times {80}^{2} \times 5}{40} \\ = 2513 N\end{matrix}$$

to which a further thrust force F′ₛ₍₅₎ has to be added generated by the vacuum (for example p′=−0.94 bar) created by the sucking device 11 inside the second chamber 24 and equal to:

$$\begin{matrix}{F}_{s ( 5 )}^{′} = \frac{π ( {D}^{2} - {d}^{2} ) p}{40} \\ = \frac{π \times ( {80}^{2} - {25}^{2} ) \times 0 , 94}{40} \\ = 426 N\end{matrix}$$

The theoretical total thrust force Fₛₜₒₜ₍ₛ₎ is thus equal to:

Fₛₜₒₜ₍₅₎=Fₛ₍₅₎+F′ₛ₍₅₎=2939N

i.e. a value very near to what is obtained by supplying the pneumatic cylinder devoid of economizer devices 50 with 6 bar pressure.

Theoretical air consumption in the thrust step Vₛ₍₅₎ (forward stroke) and in the traction step Vₜ₍₅₎ (backward stroke) are in this configuration:

$$\begin{matrix}{V}_{s ( 5 )} = \frac{π {D}^{2} ( p + 1 )}{4 \cdot {10}^{6}} c \\ = \frac{π \times {80}^{2} \times 6}{4 \cdot {10}^{6}} \times 200 \\ = 6 , 03 N 1\end{matrix}$$

$$\begin{matrix}{V}_{t ( 5 )} = \frac{π ( {D}^{2} - {d}^{2} ) ( p + 1 )}{4 \cdot {10}^{6}} c \\ = \frac{π \times ( {80}^{2} - {25}^{2} ) \times 6}{4 \cdot {10}^{6}} \times 200 \\ = 5 , 44 N 1\end{matrix}$$

Total compressed air consumption Vₜₒₜ₍₅₎ at operating pressure p=5 bar is thus Vₜₒₜ₍₅₎=Vₛ₍₅₎+Vₜ₍₅₎=11.47 Nl. It is observed that by reducing operating pressure by 1 bar it is possible to save 1.92 Nl (Vₜₒₜ₍₆₎−Vₜₒₜ₍₅₎=13.39−11.47) at each operating cycle of the pneumatic cylinder 20.

If it is assumed, purely by way of example, that the pneumatic cylinder 20, on an operating machine, performs 12 cycles a minute for 12 hours a day for 230 days a year, 1987000 cycles will be performed in a year. The annual compressed air consumption saving will be 3815 m³ of compressed air at 6 bar.

It should be noted that the greater the bore dimensions and the dimensions of the pneumatic cylinder stroke the greater will be the compressed air consumption saving.

Owing to the economizer device 1 of the invention, applied to a pneumatic cylinder, it is thus possible to obtain a considerable saving in compressed air consumption for the same performance achieved by the cylinder (thrust and traction force on the piston, speed, acceleration). In addition to a saving on the energy (e.g. electric energy) needed to supply the air-compression arrangement, the economizer device 1 of the invention also enables wear to the aforesaid compression arrangement and routine and extraordinary maintenance costs for the compression arrangement to be reduced. Lower compressed-air consumption also enables cleaning, air filtration and cooling and condensate elimination costs to be reduced. The lower energy consumption enables CO₂ emissions into the atmosphere to be reduced with clear benefits for the environment. By using lower operating pressure, the compression units are not only less stressed but are also less noisy, thus significantly lessening existing acoustic pollution (decibels/hour) in the workplace.

The economizer device 100 of the invention is thus particularly compact with modest space take-up and dimensions and is thus easily installable on any linear pneumatic actuator.

The economizer devices 1 of the invention can also be associated with a pneumatic single-action cylinder, provided in the chamber traversed by the stem with a spring for performing backward stroke.

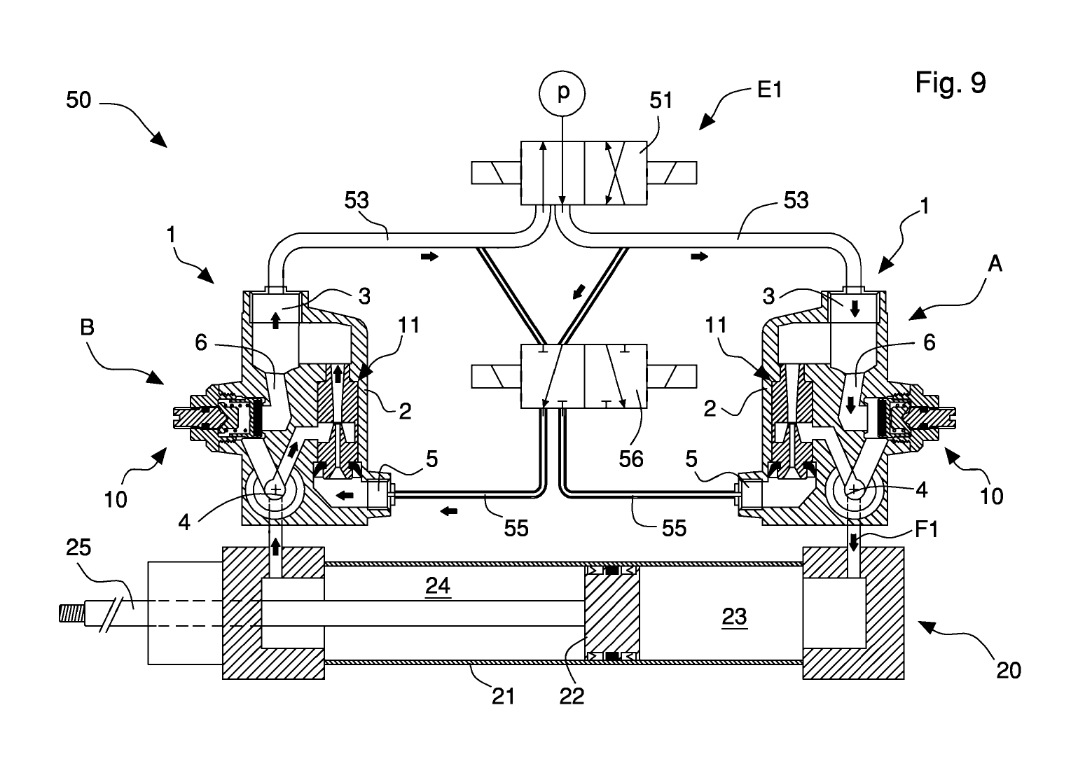

With reference to FIG. 9 there is illustrated a version of the movement apparatus 50 and a further version of the economizer device 1. In this embodiment the economizer device 1 differs from the embodiment disclosed above and illustrated in FIGS. 6 to 8, by the fact that it does not comprise the second conduit 9. In this embodiment, the third opening 5 of a device 1 is connected by a respective further supply conduit 55 to the supply conduit 53 that connects the valve switching device 51 to the respective first opening 3 of the other device 1. A further valve switching device 56 is interposed between the further supply conduits 55 and the supply conduits 53 to permit or block the air flow according to operation conditions. The further valve switching device 56 comprises, for example, a two-position four-way bistable pneumatic solenoid valve that is controlled and driven by the valve switching device 51 between a further first switching position and a further second switching position.

With reference to the operating configuration illustrated in FIG. 9, the device 1 connected to the second chamber 24 of the pneumatic actuator 20 is supplied through the respective third opening 5 with pressurized air (in such a manner as to suck air from the third conduit 8 and from the second opening 4 via the Venturi vacuum generator 11) supplied by the respective further supply conduit 55 connected to the supply conduit 53 of the device 1 connected to the first chamber 23 of the pneumatic actuator 20. The further valve switching device 56 is positioned in the further first switching position in such a manner as to permit the passage of the compressed air to the aforesaid third opening 5. The third opening 5 of the device 1 connected to the first chamber 23 is connected by the further valve switching device 56 to the supply conduit 55 of the device 1 connected to the second chamber 24. The further valve switching device 56 in the further first switching position closes the aforesaid third opening 3, preventing the passage of the air. In this manner it is possible to send compressed air into the first chamber 23 and at the same time create a vacuum in the second chamber 24 to move the piston 22 and exert a thrust force thereupon.

By switching the valve switching device 51 and the further valve switching device 56 operation of the movement apparatus 50 is reversed, which in this case will enable compressed air to be sent into the second chamber 24 and a vacuum to be created in the first chamber 23 to move the piston 22 and exert a traction force thereupon.

What is claimed is:

1. An economizer device associable with a linear pneumatic actuator having a casing and a piston slidable inside the casing and defining two chambers in the latter, said device comprising a body provided with a first opening selectively connectable to a source of pressurized air or to an environment at atmospheric pressure, a second opening connectable to a chamber of the linear pneumatic actuator and a third opening selectively connectable to a source of pressurized air, said openings being connected together by a first conduit, the device comprising a Venturi vacuum generator slidably housed and movable in said first conduit, said device being arranged for operating between a first operating configuration, in which said first opening is supplied with air at an operating pressure and said Venturi vacuum generator is movable in said first conduit to permit a primary flow of air and to reduce an outlet pressure thereof from the second opening so as to supply the chamber with air at a reduced pressure lower than said operating pressure, and a second operating configuration, in which said first opening is connected to the environment at atmospheric pressure, said third opening is supplied with pressurized air with which it supplies said Venturi vacuum generator that creates a vacuum in said opening in such a manner as to suck air from and create a vacuum in the chamber of the linear pneumatic actuator.

2. Device according to claim 1, wherein said Venturi vacuum generator comprising a further body slidably inserted in said first conduit and provided with a longitudinal variable section conduit suitable for connecting said first opening to said third opening and a transverse side passage suitable for connecting a smaller section portion of the longitudinal variable section conduit to said opening, in the second operating configuration the passage of pressurized air through said longitudinal variable section conduit determining at the smaller section portion a pressure drop by Venturi effect such as to cause air to be sucked through said side passage from the second opening and from the chamber of the linear pneumatic actuator connected thereto.

3. Device according to claim 1, wherein said Venturi vacuum generator comprising a further body inserted into said first conduit and comprising a first portion shaped in such a manner as to form with a side wall of said first conduit a gap for the passage of the air from said first opening to said opening in said first operating configuration.

4. Device according to claim 3, wherein said Venturi vacuum generator in said second operating configuration is arranged in a closed position such as to close said gap and preventing the passage of pressurized air between said second opening and said first opening.

5. Device according to claim 4, wherein said Venturi vacuum generator comprises a first seal element fixed to an end of a first portion of said further body facing said first opening and arranged for abutting on the side wall of said first conduit in such a manner as to separate said gap hermetically from said first opening in said closed position and a second seal element fixed to a second portion of said further body for abutting on the side wall of said first conduit in such a manner as to separate said gap hermetically from said third opening.

6. Device according to claim 4, comprising an elastic member acting on said Venturi vacuum generator to maintain the latter in said closed position.

7. Device according to claim 1, wherein said body comprises a front chamber interposed between the first opening and the first conduit, a rear chamber interposed between the third opening and the first conduit and a second conduit that connects the front chamber to the rear chamber to permit in the first operating configuration a secondary flow of pressurized air directed from the first opening to the rear chamber, the pressurized air in said front chamber and the pressurized air in said rear chamber exerting respective opposite thrusts on said Venturi vacuum generator such as to move the latter inside and along said first conduit.

8. Device according to claim 7, comprising an on-off member for enabling, in the first operating configuration, the passage of the secondary flow of air through said second conduit directed from said first opening to said third opening and prevent, in the second operating configuration, a flow of air through said second conduit directed from said third opening to said first opening.

9. Device according to claim 8, wherein said on-off member comprises an annular lip seal fixed to an end of said Venturi vacuum generator at said rear chamber.

10. Movement apparatus comprising a linear pneumatic actuator provided with a casing and with a piston that is slidable inside said casing and defines a first chamber and a second chamber inside the latter, said apparatus comprising an economizer device according to any preceding claim, associated with said second chamber, wherein a first opening of said device is selectively connectable to a source of pressurized air or to an environment at atmospheric pressure, a second opening of said device is connected to said second chamber, a third opening of said device is connectable to a source of pressurized air, said first chamber being selectively connectable to a source of pressurized air or to an environment at atmospheric pressure.

11. Apparatus according to claim 10, comprising a valve switching device connected to said first opening, to said third opening and to said first chamber, said valve switching device being selectively activatable at least between:
a first switching position for connecting the first opening to an environment at atmospheric pressure and sending pressurized air to the first chamber to move the piston and in the third opening to enable air to be extracted from the second chamber through the device arranged in a second operating configuration in such a manner that to a force generated on said piston by the pressurized air in the first chamber a further force is added that is generated by the vacuum made in the second chamber; and
a second switching position for connecting the first chamber to an environment at atmospheric pressure and sending pressurized air to said first opening of the device arranged in a first operating configuration such as to reduce an air supply pressure in said second chamber and thus air consumption in movement of the piston.

12. Apparatus according to claim 11, comprising an on-off valve arrangement interposed between said third opening and said valve switching device and activatable via a sensor by said piston to allow or prevent the passage of pressurized air in said third opening on the basis of a linear position of said piston along said casing.

13. Apparatus according to claim 10, comprising a respective device associated with said first chamber, wherein a respective first opening of said device is selectively connectable to a source of pressurized air or to an environment at atmospheric pressure, a respective second opening of said device is connected to said first chamber, a respective third opening of said device is connected to the respective third opening of the device associated with the second chamber.

14. Apparatus according to claim 13, comprising a valve switching device that is connected to the first openings of said devices and is selectively activatable for sending pressurized air into one of said chambers through a respective device arranged in a first operating configuration and to enable air to be extracted from the remaining chamber through a respective device arranged in a second operating configuration so as to enable said piston to be moved, in particular in such a manner that to a force generated on said piston by the pressurized air in a chamber a further force is added that is generated by the vacuum made in the remaining chamber.

15. Apparatus according to claim 14, wherein the device arranged in the second operating configuration has the respective first opening connected to an environment at atmospheric pressure by the valve switching device and receives incoming pressurized air from the respective third opening supplied by pressurized air exiting the respective third opening of the other device that is arranged in the first operating configuration.

16. Apparatus according to claim 10, wherein said device is removably connected to said casing, in particular said second opening being connected to said second chamber by a pneumatic connecting arrangement.

17. Apparatus according to claim 10, wherein said device is integrated into said casing.

18. Method for driving a linear pneumatic actuator comprising a casing and a piston that is slidable inside said casing and defining two chambers in the latter, said driving comprising supplying with pressurized air one of said chambers and sucking air from and creating a vacuum in the remaining chamber in such a manner that to a force generated on said piston by the pressurized air in a chamber a further force is added generated by the vacuum created in the remaining chamber.

19. Method according to claim 18, wherein said sucking is achieved by a Venturi vacuum generator supplied with a secondary flow of said pressurized air.

20. Movement apparatus comprising a linear pneumatic actuator provided with a casing and with a piston that is slidable inside said casing and defines a first chamber and a second chamber inside the latter, and an economizer device associated with said second chamber and provided with a body having a first opening selectively connectable to a source of pressurized air or to an environment at atmospheric pressure, a second opening connectable to said second chamber and connected to said first opening by a first conduit, a third opening selectively connectable to a source of pressurized air and connected to said first opening and to said opening by a Venturi vacuum generator, said device being arranged for operating between a first operating configuration, in which said first opening is supplied with pressurized air to permit a primary flow of air through said first conduit to supply said second chamber, and a second operating configuration, in which said first opening is connected to the environment at atmospheric pressure, said third opening is supplied with pressurized air with which it supplies said Venturi vacuum generator, which creates a vacuum in the second opening in such a manner as to suck air from, and create a vacuum, said second chamber.

21. Apparatus according to claim 20, wherein the Venturi vacuum generator comprises a further body provided with a longitudinal variable section conduit suitable for connecting the first opening to the third opening and a transverse side passage that is suitable for connecting a smaller section portion of the longitudinal variable section conduit to the second opening, the passage of pressurized air through said longitudinal variable section conduit determining at the smaller section portion a pressure drop by Venturi effect that is such as to cause air to be sucked through the side passage from the second opening and from the chamber of the linear pneumatic actuator connected thereto.

22. Apparatus according to claim 20, comprising a valve switching device connected to said first opening and to said third opening of said device and to said first chamber of said linear pneumatic actuator, said valve switching device being selectively activatable at least between:
a first switching position for connecting the first opening to an environment at atmospheric pressure and sending pressurized air to the first chamber to move the piston and to the third opening to enable air to be extracted from the second chamber through the device, arranged in a second operating configuration, in such a manner that to a force generated on said piston by the pressurized air in the first chamber a further force is added that is generated by the vacuum made in the second chamber; and
a second switching position for connecting the first chamber to an environment at atmospheric pressure and sending pressurized air to said first opening of said device, arranged in a first operating configuration.

23. Apparatus according to claim 22, comprising an on-off valve arrangement interposed between said third opening and said valve switching device and activatable via a sensor by said piston to permit or prevent the passage of pressurized air to said third opening on the basis of at least one linear position of said piston along said casing.

24. Apparatus according to claim 20, comprising a respective device associated with said first chamber, wherein a respective first opening of said device is selectively connectable to a source of pressurized air or to an environment at atmospheric pressure, a respective second opening of said device is connected to said first chamber, a respective third opening of said device is connected to the respective third opening of the device associated with the second chamber.

25. Apparatus according to claim 24, comprising a valve switching device connected to the first openings of said devices and selectively activatable for sending pressurized air to one of said chambers through a respective device arranged in a first operating configuration and to enable air to be extracted from the remaining chamber through a respective device arranged in a second operating configuration such as to enable said piston to be moved, in particular in such a manner that to a force generated on said piston by the pressurized air in a chamber a further force is added that is generated by the vacuum made in the remaining chamber.

26. Apparatus according to claim 25, wherein the device arranged in the second operating configuration has the respective first opening connected to an environment at atmospheric pressure by the valve switching device and receives incoming pressurized air from the respective third opening supplied by pressurized air exiting the respective third opening of the other device that is arranged in the first operating configuration.

27. Apparatus according to claim 20, wherein said device comprises a valve arrangement inserted into said first conduit and arranged for permitting said primary flow of pressurized air in the first operating configuration and for preventing the passage of air through said first conduit in the second operating configuration.

28. Apparatus according to claim 20, wherein said body comprises a second conduit that connects said first opening to said third opening to permit a secondary flow of pressurized air from said first opening exiting said third opening, in said first operating configuration.

29. Apparatus according to claim 20, wherein said third opening is connected to said first opening, by a third conduit into which said Venturi vacuum generator is inserted, and to said second opening, by a fourth conduit leading into said Venturi vacuum generator.

30. Apparatus according to claim 29, comprising a seal element inserted into said third conduit respectively to permit an air flow through said second conduit directed form said first opening to said third opening, in said first operating configuration, and to prevent a flow of air through said second conduit directed from said third opening to said first opening, in said second operating configuration.

31. Apparatus according to claim 29, wherein said Venturi vacuum generator is inserted into said third conduit.

32. Apparatus according to claim 20, wherein said Venturi vacuum generator is slidably housed and is movable in the first conduit in such a manner that in said first operating configuration, in which the first opening is supplied at an operating pressure, said Venturi vacuum generator is movable in the first conduit to permit the passage into the latter of the primary air flow and to reduce an outlet pressure of said primary air flow from the second opening so as to supply said second chamber with air at a reduced pressure lower than said operating pressure.

33. Apparatus according to claim 32, wherein the Venturi vacuum generator includes a further body slidably inserted into in said first conduit and comprising a first portion shaped in such a manner as to form with a side wall of said first conduit a gap for the passage of the air from said first opening to said second opening in said first operating configuration.

34. Apparatus according to claim 33, wherein said Venturi vacuum generator in said second operating configuration is arranged in a closed position such as to close said gap and preventing the passage of pressurized air between said second opening and said first opening.

35. Apparatus according to claim 34, wherein said Venturi vacuum generator comprises a first seal element fixed to an end of a first portion of said further body facing said first opening for abutting on the side wall of said first conduit in such a manner as to separate said gap hermetically from said first opening in said closed position and a second seal element fixed to a second portion of said further body for abutting on the side wall of said first conduit in such a manner as to separate said gap hermetically from said third opening.

36. Apparatus according to claim 34, comprising an elastic member acting on said Venturi vacuum generator to maintain the latter in said closed position.

37. Apparatus according to claim 32, wherein said body comprises a front chamber interposed between the first opening and the first conduit, a rear chamber interposed between the third opening and the first conduit and a second conduit that connects the front chamber to the rear chamber to permit in the first operating configuration a secondary flow of pressurized air directed from the first opening to the rear chamber, the pressurized air in said front chamber and the pressurized air in said rear chamber exerting respective opposite longitudinal thrusts on said Venturi vacuum generator that are such as to move the latter along said first conduit.

38. Apparatus according to claim 37, comprising an on-off member to permit, in the first operating configuration, the passage of the secondary flow of air through said second conduit directed from said first opening to said third opening, and prevent, in the second operating configuration, an air flow through said second conduit directed from said third opening to said first opening.

39. Apparatus according to claim 38, wherein said on-off member comprises an annular lip seal fixed to an end of said Venturi vacuum generator at said rear chamber.
